(19) United States
(12) Patent Application Publication
(10) Pub. No.: US 2011/0221695 A1
(43) Pub. Date: Sep. 15, 2011

(54) TOUCH PANEL AND TOUCH SENSING METHOD THEREOF

(76) Inventor: Tung-Ke Wu, Taipei City (TW)

(21) Appl. No.: 13/046,386

(22) Filed: Mar. 11, 2011

(30) Foreign Application Priority Data
Mar. 12, 2010 (TW) 099107368

(51) Int. Cl. G06F 3/041

(52) U.S. Cl. 345/173

(57) ABSTRACT

A touch sensing method includes providing a touch panel having a plurality of axial sensor chains disposed side by side, wherein each of the sensor chains outputs a signal. The touch sensing method generates a plurality of determination data based on the signals, wherein each of the determination data corresponds to one of the sensor chains or to a plurality of sensor pairs formed by two adjacent sensor chains. When two adjacent determination data are respectively greater than and smaller than a base value, the touch sensing method will determine a touch point based on locations of the sensor pairs or locations of the sensor chains corresponding to the determination data.

### CROSS-REFERENCE TO RELATED APPLICATION

This application claims priority based on Taiwanese Patent Application No. 099107368, filed on Mar. 12, 2010, the disclosure of which is incorporated herein by reference in its entirety.

### BACKGROUND OF THE INVENTION

1. Field of the Invention

The present invention relates to a touch panel and a touch sensing method thereof, specifically to a capacitive touch panel and a touch sensing method thereof.

2. Description of the Prior Art

Touch panels are currently the market standard on the market and are widely used in cellular phones, monitors, and laptop computers to allow electronic products to receive user commands through touch sensing while simultaneously display images. Furthermore, multi-point touch panels capable of multi-point sensing are also gradually replacing single-point touch panels. Through the multi-touch sensing feature, electronic products can provide application features not possible with conventional single-point touch panels.

FIG. 1A is a schematic view of a conventional touch panel 10, wherein the conventional touch panel 10 in FIG. 1A is a capacitive touch panel. The conventional touch panel 10 includes a plurality of X-axis sensors X1, X2, X3, X4, X5, X6, X7, and X8 as well as a plurality of Y-axis sensors Y1, Y2, Y3, Y4, Y5, Y6, Y7, and Y8. FIG. 1A also shows X-axis sensor signals x1, x2, x3, x4, x5, x6, x7, and x8 as well as Y-axis sensor signals y1 , y2, y3, y4, y5, y6, y7, and y8. As shown in FIG. 1A, a user touches the conventional touch panel 10 to form a first touch-point 600. Due to changes to the overall effective capacitance of the X-axis sensor X7 and the Y-axis sensor Y3 as a result of the user touching the conventional touch panel 10, the sensor signals x7 and y3 outputted from their corresponding X-axis sensor X7 and Y-axis sensor Y3 are resultantly greater than the sensor signals outputted from the other sensors. After receiving signals from the X-axis sensors, a signal processing module (not shown) of the conventional touch panel 10 will determine the X-coordinate of the center point of the first touch point 600 on the X-axis according to the location of the X-axis sensor corresponding to the greatest signal. Similarly, the signal processing module will determine the Y-coordinate of the first touch point 600 based on the location of the Y-axis sensor generating the greatest signal. Afterward the signal processing module of the conventional touch panel 10 will determine the coordinate of the first touch point 600 as (X7, Y3).

Furthermore, the conventional touch panel 10 illustrated in FIG. 1B further includes a second touch point 610, wherein the second touch point 610 causes the signal y5 generated by the Y-axis sensor Y5 to be greater than the signal y4 generated by the Y-axis sensor Y4. The signal processing module of the conventional touch panel 10 will detect signals y3 and y5 with the greatest amplitude as well as the signal y4 with smaller amplitude in order to determine the existence of both the first touch point 600 and the second touch point 610. This shows that the above-mentioned conventional touch panel detects signals and uses the amplitude of each signal to determine a touch point or a plurality of touch points.

However, the above-mentioned algorithm will require repetitive detection and comparison of signals and thus require a great amount of calculation resources and may result in inferior calculation efficiency.

Furthermore, the algorithm mentioned above has not excluded the ambient noise from the calculation of coordinate and thus the ambient noise may affect the signal-noise-ratio of the conventional touch panel and even the accuracy of the coordinate calculation.

### SUMMARY OF THE INVENTION

It is an object of the present invention to provide a touch panel with multi-touch functionality and a touch sensing method thereof.

It is another object of the present invention to provide a touch panel and a touch sensing method thereof with improved sensing accuracy.

The present invention includes a touch panel and a touch sensing method thereof, wherein the touch sensing method includes providing a touch panel with a plurality of axial sensor chains disposed side by side, wherein each one of the axial sensor chains outputs a signal. The touch sensing method then generates a plurality of determination data based on the signals from the sensor chains, wherein each of the determination data corresponds to one of the sensor chains or to a plurality of sensor pairs each formed by two adjacent axial sensors. When two adjacent determination data are respectively greater than and smaller than a base value, the touch sensing method will determine a touch point based on locations of the sensor pairs or locations of the sensor chains corresponding to the determination data. In other words, when a touch point occurs on the touch panel, if signals from two adjacent sensor chains are respectively greater than and smaller than the base value, then a signal processing module of the touch panel will determine the location/coordinates of touch point based on locations of the sensor chains corresponding to the signals.

In different embodiments, the touch panel of the present invention includes a plurality of sensor pairs, wherein each of the sensor pairs includes two adjacent axial sensor chains. The signal processing module of the touch panel generates a differential value based on the signals generated by the sensor chains in each sensor pair. When a touch point occurs on the touch panel and when two adjacent differential values are respectively greater than and smaller than the base value, the signal processing module will then determine the location of the touch point based on the locations of sensor pairs corresponding to the differential values.

Furthermore, the touch sensing method further includes setting a threshold value, wherein the threshold value represents an average amplitude of ambient signal noise. Therefore, even if adjacent signals are respectively greater than and smaller than the base value, the difference between at least one of the signals and the base value needs to be greater than the threshold value in order for the signal processing module to determine the touch point. Thus, using the threshold allows the touch sensing method of the present invention to avoid the possibility of detecting non-existent touch point that are due to ambient signal noises.

### BRIEF DESCRIPTION OF THE DRAWINGS

FIG. 1A and FIG. 1B are schematic views of the conventional touch panel;

FIG. 2A, FIG. 2B, and FIG. 2C are schematic views of the touch panel of the present invention;

FIG. 3 illustrates another embodiment of the touch panel illustrated in FIG. 2A, FIG. 2B, and FIG. 2C;

FIG. 4A, FIG. 4B, FIG. 4C, and FIG. 5 illustrates variations of the touch panel illustrated in FIG. 2A, FIG. 2B, FIG. 2C;

FIG. 6 is a flow chart illustrating the touch sensing method of the present invention; and

FIG. 7 and FIG. 8 are variations of the touch sensing method illustrated in FIG. 6.

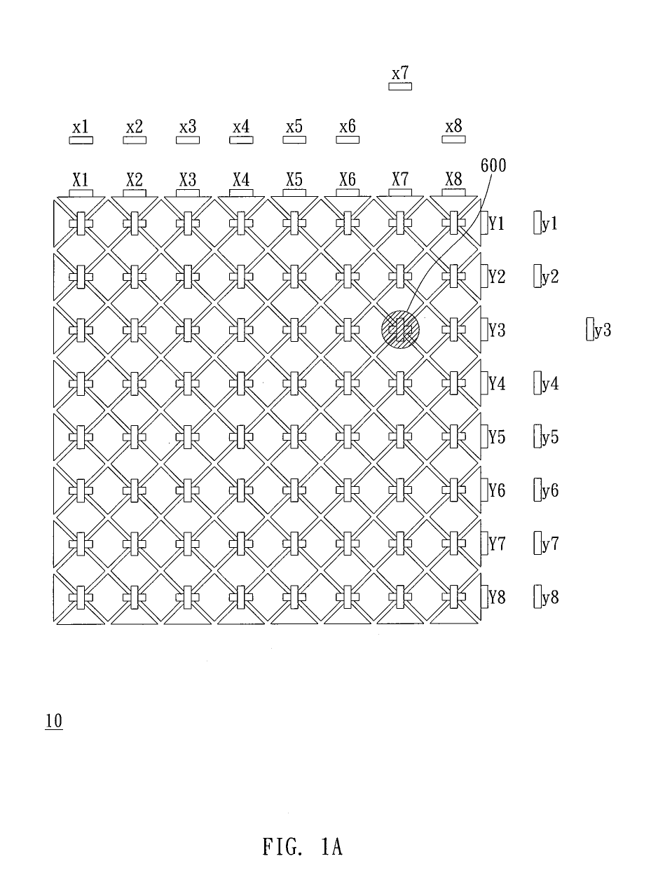

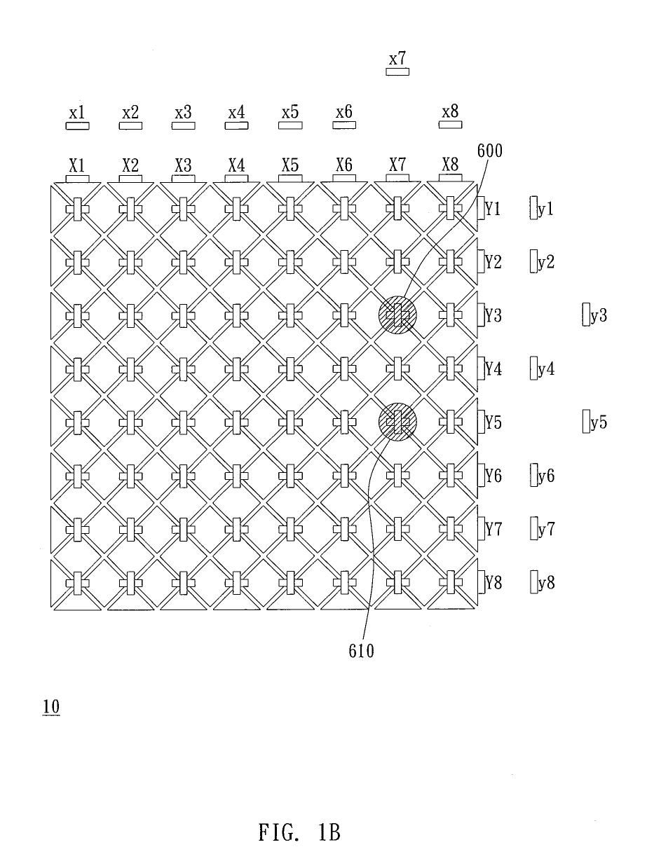

### DETAILED DESCRIPTION OF THE PREFERRED EMBODIMENT

The present invention discloses a touch panel and a touch sensing method thereof. Specifically, the present invention discloses a touch panel with multi-touch functionalities. It is an object of the present invention to provide a touch panel and a touch sensing method which generates a plurality of determination data based on signals generated by a plurality of axial sensors, wherein the determination data each corresponds to one of the axial sensor chains and one of the sensor pairs each formed by two adjacent axial sensor chains. Concurrently, the touch sensing method of the present invention will define a base value, wherein when two adjacent signals are respectively greater than and smaller than the base value, the touch sensing method will determine location of touch point based on locations of the axial sensors corresponding to the signals.

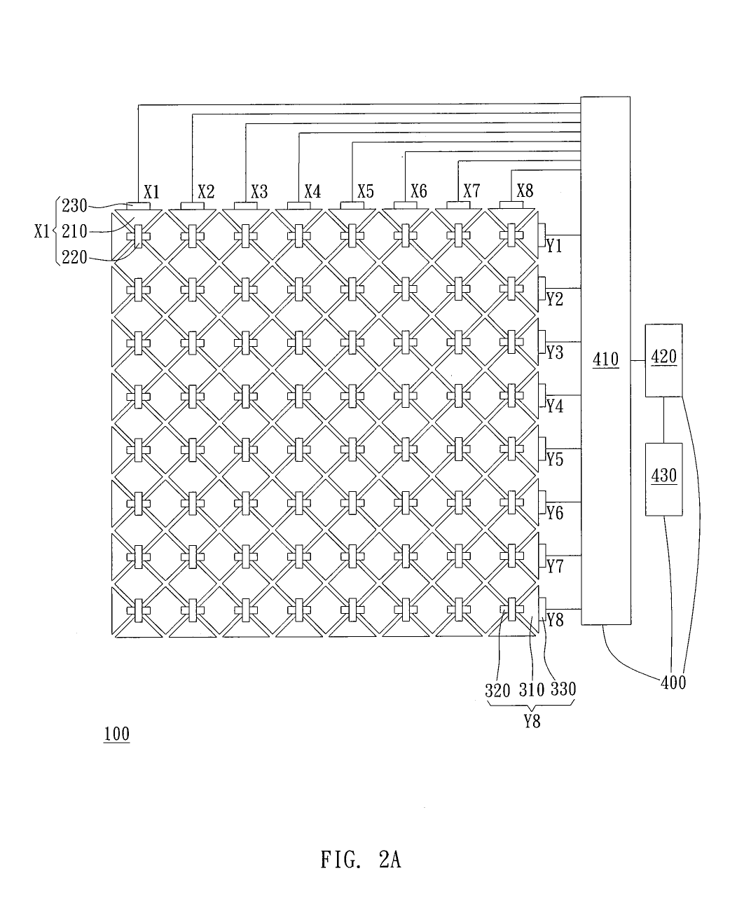

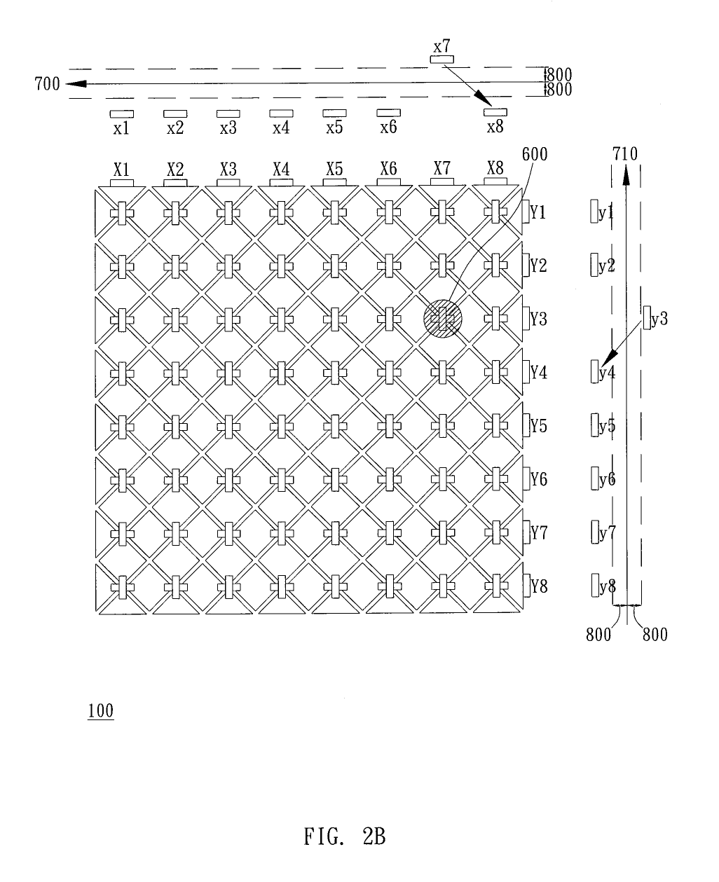

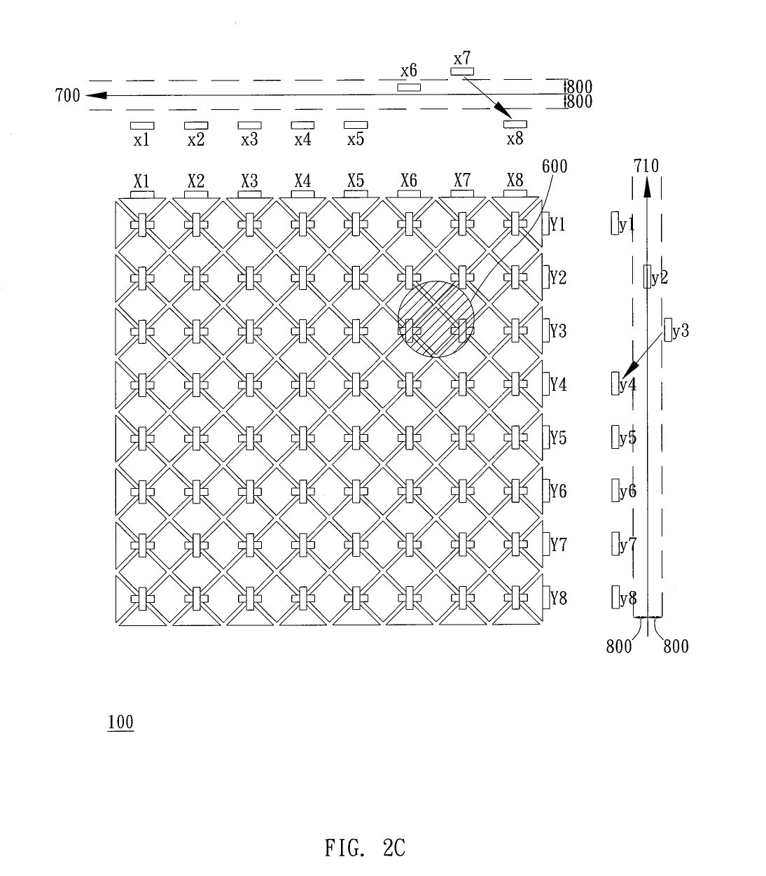

FIG. 2A is a schematic view of the touch panel 100, wherein the touch panel 100 of the present embodiment is a capacitive touch panel. As FIG. 2A shows, the touch panel 100 includes a plurality of X-axis sensor chains X1,

X2, X3, X4, X5, X6, X7, X8 and a plurality of Y-axis sensor chains Y1, Y2, Y3, Y4, Y5, Y6, Y7, Y8, and a signal processing module 400, wherein the signal processing module 400 includes a multiplexer 410, an analogue-to-digital converter 420, and a coordinate calculation module 430. The X-axis sensor chains X1, X2, X3, X4, X5, X6, X7, and X8 are disposed side by side, wherein each of the X-axis sensor chains includes a plurality of X-axis sensors 210 and a plurality of X-axis connectors 220. Each X-axis connector 220 is electrically connected to adjacent X-axis sensors 210 so that those two X-axis sensors 210 are electrically connected to each other via the X-axis connectors 220. Similarly, Y-axis sensor chains Y1, Y2, Y3, Y4, Y5, Y6, Y7, Y8 are disposed side by side, wherein each of the Y-axis sensor chains Y1, Y2, Y3,Y4, Y5, Y6, Y7, Y8 includes a plurality of Y-axis sensors 310 and a plurality of Y-axis connectors 320. Each of the Y-axis connectors 320 is connected adjacent Y-axis sensors 310 so that those two Y-axis sensors 310 are electrically connected to each other via the Y-axis connector 320. Furthermore, the X-axis sensors 210 and the Y-axis sensors 310 overlapping each other are insulated and therefore will not short-circuit each other.

As FIG. 2A shows, each of the X-axis sensor chains X1, X2, X3, X4, X5, X6, X7, and X8 has an X-axis electrode 230, wherein the X-axis electrode 230 is located at one end of the corresponding X-axis sensor chain X1, X2, X3,

X4, X5, X6, X7, X8. Similarly, each of the Y-axis sensor chains Y1, Y2, Y3, Y4, Y5, Y6, Y7, and Y8 has a Y-axis electrode 330, wherein the Y-axis electrode 330 is located at one end of the corresponding Y-axis sensor chain Y1, Y2, Y3, Y4, Y5, Y6, Y7, Y8. The X-axis electrodes 230 and the Y-axis electrodes 330 are electrically connected to the multiplexer 410, wherein the multiplexer 410 receives signals from the X-axis sensor chains X1, X2, X3, X4, X5, X6, X7, and X8 and the Y-axis sensor chains Y1, Y2, Y3, Y4, Y5, Y6, Y7, and Y8 and transmits them to the analogue-to-digital converter 420. Afterward the analogue-to-digital converter 420 transforms the signals into digital signals and then transmits those digital signals to the coordinate calculation module 430 for determining the location of touch point. In the present embodiment, signals from the X-axis sensor chains X1, X2, X3, X4, X5, X6, X7, X8 and the Y-axis sensor chains Y1, Y2, Y3, Y4, Y5, Y6, Y7, Y8 are all electric voltages, but are not limited thereto; in different embodiments, the above-mentioned signals can be electric current or other data format representing locations of the X-axis sensor chains X1, X2, X3, X4, X5, X6, X7, X8 and the Y-axis sensor chains Y1, Y2, Y3, Y4, Y5, Y6, Y7, Y8.

FIG. 2B is another schematic view illustrating the touch panel 100 in FIG. 2A, wherein the X-axis sensor chains X1, X2, X3, X4, X5, X6, X7, X8 output a plurality of X-axis signals x1, x2, x3, x4, x5, x6, x7, x8 via the X-axis electrodes 230 in a first period. Similarly, the Y-axis sensor chains Y1, Y2, Y3, Y4, Y5, Y6, Y7, Y8 output a plurality of Y-axis signals y1, y2, y3, y4, y5, y6, y7, y8 via Y-axis electrodes 330 in the first period. In more preferred embodiments, all the X-axis signals x1, x2, x3, x4, x5, x6, x7, x8 are outputted in the first period simultaneously; however, in different embodiments, X-axis signals x1, x2, x3, x4, x5, x6, x7, x8 can be outputted at different time slots within the first period. In the present embodiment, the user touches the touch panel 100 to form a first touch point 600, wherein user's touch alters the overall effective capacitance of the X-axis sensor chain X7 and that of the Y-axis sensor chain Y3, therefore signals generated by the X-axis sensor chain X7 and the Y-axis sensor chain Y3 are higher than those outputted by other sensor chains. Furthermore, the area of sensor covered by the first touch point 600 is positively correlated to the amplitude of the signal outputted by the corresponding sensor chain, but is not limited thereto; in different embodiments, the area of sensor covered by the first touch point 600 can be negatively correlated to the amplitude of the signal outputted by that sensor chain.

In the embodiment illustrated in FIG. 2B, a first base value 700 and a second base value 710 are defined in the touch panel 100. As FIG. 2B shows, the area of the X-axis sensor chain X7 covered by the first touch point 600 is greatest amongst the X-axis sensor chains X1, X2, X3, X4, X5, X6, X7, X8 and therefore the amplitude of X-axis signal x7 is greater than other X-axis signals. Furthermore, the amplitude of the X-axis signals x6 and x7 are respectively smaller than and greater than the first base value 700, whereas the X-axis signals x7 and x8 are greater than and smaller than the first base value 700, respectively. The coordinate calculation module 430 will detect the relationship between X-axis signals x6, x7, and x8 and the first base value 700 mentioned above after receiving those X-axis signals. The coordinate calculation module 430 then determines that the location of the X-axis sensor chain X7 corresponding to the X-axis signal x7 as the X-axis coordinate of the first touch point 600. Similarly, the coordinate calculation module 430 will determine the location of the Y-axis sensor chain Y3 corresponding to the Y-axis signal y3 as the Y-axis coordinate of the first touch point 600, based on the second base value 710. This shows that each of the X-axis signals and each of the Y-axis signals can be used to determine the first touch point 600.

Furthermore, as FIG. 2B shows, in order to take the ambient noise into consideration during touch sensing, the touch panel 100 of the present embodiment further sets a threshold value 800 representing the average ambient noise which may interfere the touch sensing. In the present embodiment, one of the criterions for determining coordinates is that when two adjacent X-axis signals are respectively greater than and smaller than the first base value 700, at least the difference between one of the two X-axis signals and the first base value 700 is greater than the threshold value 800. In this way, the touch panel 100 can reduce the possibility of false detection even if the amplitude of ambient noise is greater than that of the first base value 700. For instance, as FIG. 2B shows, even if the X-axis signal x7 is greater that the first base value 700, the coordinate calculation module 430 still needs to make sure that the difference between the X-axis signal x7 and the first base value 700 is greater than the threshold value 800 in order to determine that the location of the X-axis sensor chain X7 as the X-axis coordinate of the first touch point 600. In the embodiment illustrated in FIG. 2B, the difference of at least one X-axis signal and the first base value 700 is required to be greater than the threshold value 800 in order to determine a valid coordinate, but is not limited thereto. In different embodiments, the touch panel 100 can require the differences of two X-axis signals and the first base value 700 to be both greater than the threshold value 800.

FIG. 2C illustrates a variation of the touch panel 100 illustrated in FIG. 2A and FIG. 2B. In the present embodiment, the area of first touch point 600 is greater than the area of first touch point 600 and covers both the X-axis sensors X6 and X7. The X-axis signals x6, x7 generated by the X-axis sensor chains X6, X7 are both greater than the first base value 700. However, as FIG.

2C shows, the amplitude of X-axis signals x7 is greater than that of the X-axis signal x6, therefore the coordinate calculation module 430 initially determines the location of X-axis sensor chain X7 as the center of first touch point 600. Then, the coordinate calculation module 430 will calculate the difference between the X-axis signals x6 and x7 and adjust the X-axis coordinate of the centre of the first touch point 600 based on the difference calculated. In other words, the centre of first touch point 600 determined by the coordinate calculation module 430 is located between the X-axis sensor chains X6 and X7. Similarly, the Y-coordinate of the centre of first touch point 600 is determined to be located between the Y-axis sensors Y2 and Y3.

Furthermore, after the location of the centre of first touch point 600 is initially determined, the coordinate calculation module 430 will capture one or more X-axis signals adjacent to the X-axis signals x7 and use interpolation, dispersion or other algorithms to obtain a more precise coordinate of the first touch point 600 on the X-axis. Similarly, Y-axis signals adjacent to the Y-axis signal y3 can also be used to obtain a more precise coordinate of the first touch point 600 on the Y-axis. In the present embodiment, the coordinate calculation module 430 use X-axis signals x6, x8 adjacent to the X-axis signal x7 in order to determine the location of first touch point 600 on the X-axis, but is not limited thereto. The coordinate calculation module 430 can also use the difference between other X-axis signals and the X-axis signal x7 in order to obtain a more precise approximation of first touch point's 600 coordinate on the X-axis, but is not limited thereto. Similarly, in addition to Y-axis signals y2, y3, and y4, other Y-axis signals can also be used to calculate the precise location of first touch point 600 on the Y-axis. The description above shows that even if the first touch point 600 does not have a fixed area, the coordinate calculation module 430 can still determine the centre of first touch point 600 based on amplitude of signals and repetitive calibration.

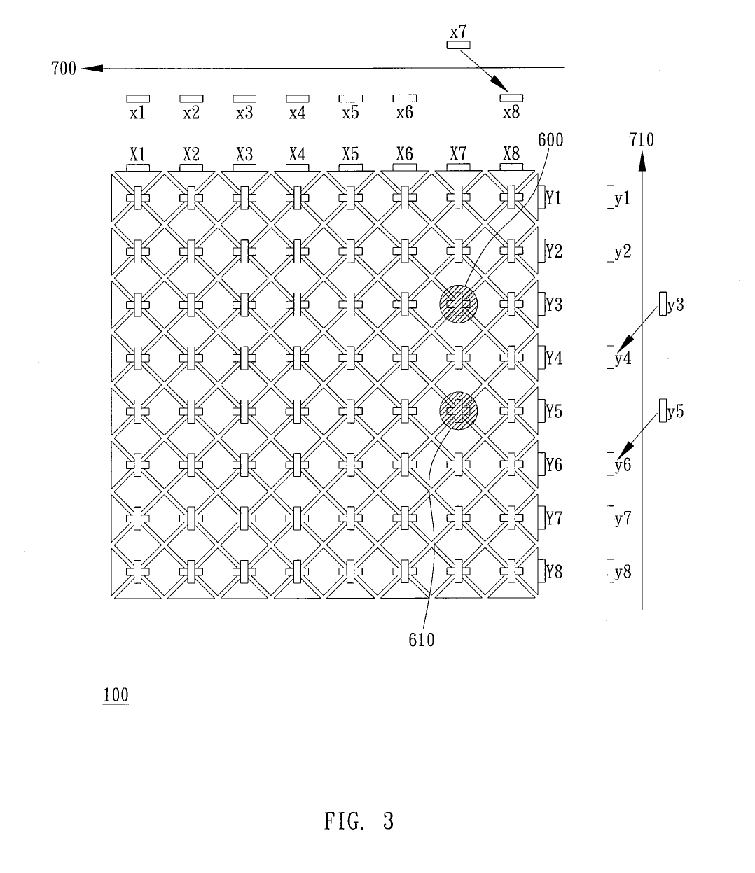

FIG. 3 is a variation of the touch panel 100 illustrated in FIG. 2A. As FIG. 3 shows, a user touches the touch panel 100 to form a first touch point 600 and a second touch point 610 on the touch panel 100. In the present embodiment, the touch panel 100 includes a first base value 700 and a second base value 710 corresponding to the X-axis signals and the Y-axis signals, respectively. The first touch point 600 and the second touch point 610 are located on the X-axis sensor chain X7 and therefore the X-axis signal x7 corresponding to the X-axis sensor chain X7 is higher than the first base value 700. Furthermore, the X-axis signals x7, x8 are respectively greater than and smaller than the first base value 700, and therefore the coordinate calculation module 430 determines the location of the X-axis sensor chain X7 as the locations of touch points on the X-axis. In the mean while, the coordinate calculation module 430 still needs more information in order to determine whether one or more touch points occur on the touch panel 100.

Furthermore, the first touch point 600 and the second touch point 610 are respectively located on the Y-axis sensor chains Y3 and Y5, and therefore the Y-axis signals y3, y5 corresponding to the Y-axis sensor chains Y3 and Y5 are both higher than the second base value 710. The Y-axis sensor chain Y4 is not covered by the first touch point 600 and the second touch point 610 and therefore the amplitude of Y-axis signal y4 from the Y-axis sensor chain Y4 is smaller than the second base value 710. After obtaining all the X-axis signals and the Y-axis signals, the coordinate calculation module 430 will detect that the Y-axis signals y3, y4 from the Y-axis sensor chains Y3 and Y4 are respectively greater than and smaller than the second base value 710 and determine that the location of Y-axis sensor chain Y3 as the Y-coordinate of first touch point 600. Similarly, the location of Y-axis sensor chain Y5 is determined as the Y-coordinate of second touch point 610. Afterward the coordinate calculation module 430 will achieve multi-touch sensing by determining the coordinate of the centre of first touch point 600 as (X7, Y3) and the coordinate of the centre of second touch point 610 as (X7, Y5). Furthermore, the coordinate calculation module 430 can use interpolation, dispersion or other algorithm after obtaining other X-axis signals and other Y-axis signals to calculate a more precise coordinate of the first touch point 600 and the second touch point 610. The touch panel 100 of the present embodiment is used to determine the coordinates of two touch points 600 and 610, but is not limited thereto; in different embodiments, the touch panel 100 can be used to detect coordinates of other numbers of touch point.

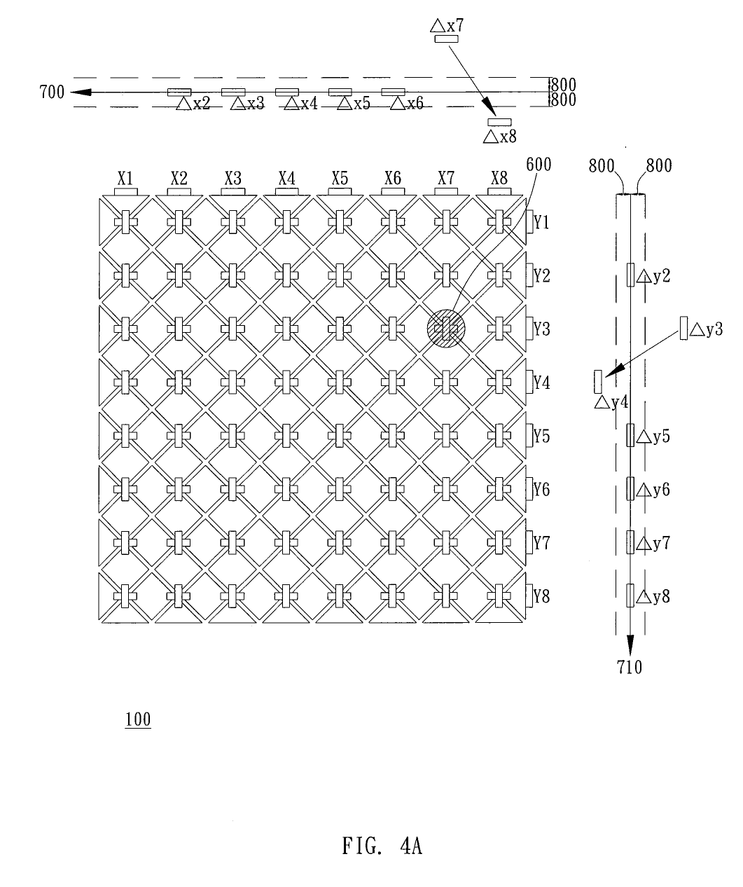

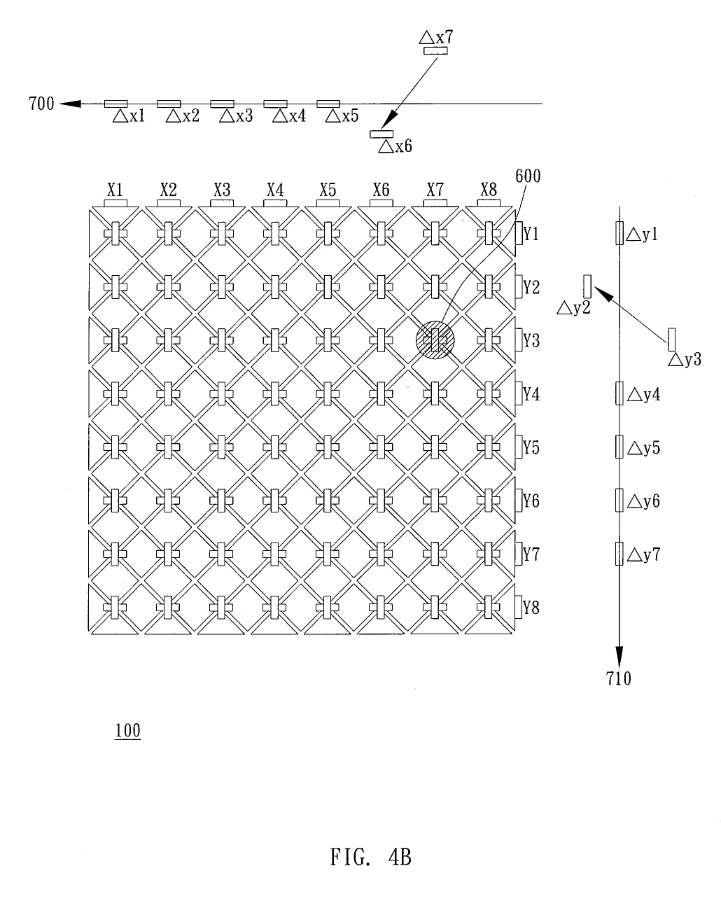

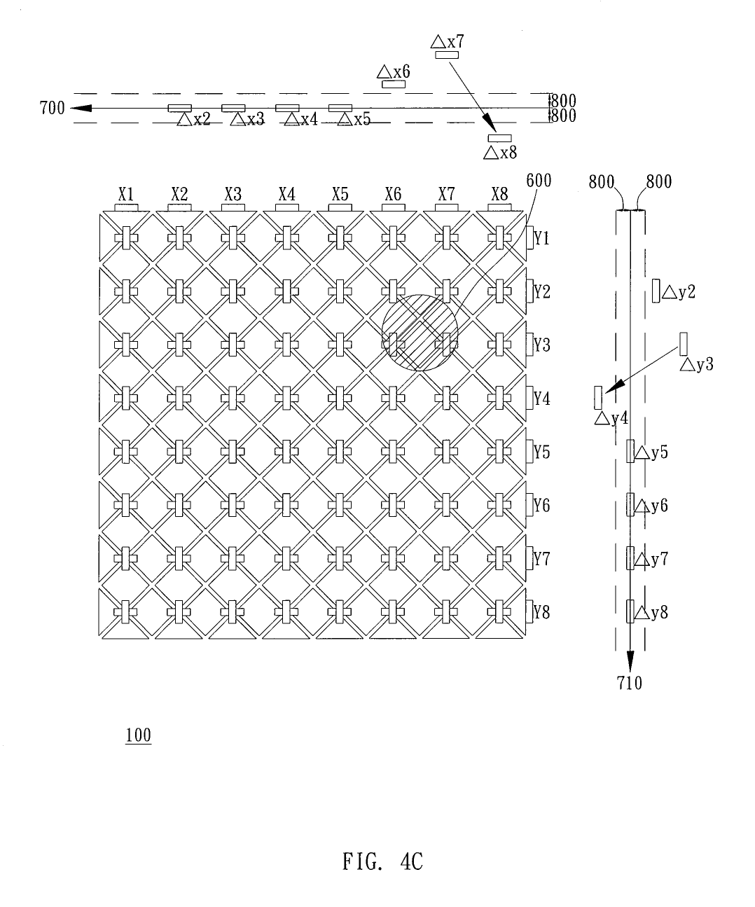

FIG. 4A is a variation of the touch panel 100 illustrated in FIG. 2A. The touch panel 100 generates a plurality of X-axis differential values Δ x2, Δ x3, Δ x4, Δ x5, Δ x6, Δ x7, and x8 and a plurality of Y-axis differential values Δ y2, Δ y3, Δ y4, Δ y5, Δ y6, Δ y7, and Δ y8. In more preferred embodiments, all the X-axis differential values and all the Y-axis differential values are generated simultaneously in a first period. Here please refer to both FIG. 2B and FIG. 4A. In the present embodiment, two adjacent X-axis sensors are arranged into a sensor pair, wherein two X-axis signals from the X-axis sensor chains from each sensor pair are used to calculate the X-axis differential value, wherein the X-axis differential value represents the difference between X-axis signals generated by adjacent X-axis sensor chains. In other words, the X-axis differential value is the difference in amplitudes of the X-axis signals of the X-axis sensor chains in the sensor pair. For instance, the X-axis differential value Δ x2 is the difference between the X-axis signals x2, x1 from the X-sensor chains X2, X1, respectively. Similarly, two adjacent Y-axis sensors are arranged into a sensor pair which then generates a Y-axis differential value. For instance, the Y-axis differential value Δ y2 is the difference between the Y-axis signals y2, yl generated by the Y-axis sensor chains Y2, Y1, respectively.

Furthermore, the differential values of the present embodiment are used to eliminate ambient noise within the X-axis signals and the Y-axis signals. Here please refer to FIG. 2B, FIG. 4A and formula (1), wherein N in the formula (1) represents the ambient noise.

(x2+N)−(x1+N)=x2−x1=Δx2 (1)

It can be seen from formula (1) that the use of differential values allows the touch panel 100 to eliminate the common-mode noise existing within the signals in order to attain the desired signal-noise ratio.

Furthermore, in the embodiment illustrated in FIG. 4A, the touch panel 100 has a first base value 700 which is defined as the difference between X-axis signals of the X-axis sensors not covered by the first touch point 600. In the present embodiment, when the sensor pair is not covered by the first touch point 600, the X-axis signals generated by the X-axis sensors are substantially equal and therefore the corresponding X-axis differential value is zero. However, in different embodiments, the first base value 700 can also have other value.

Here please refer to FIG. 2A and FIG. 4A, wherein the X-axis sensor chain X8 is not covered by the first touch point 600 and therefore the X-axis signal x8 is smaller than the X-axis signal x7 of the X-axis sensor chain X7. In this way, the X-axis differential value Δ x8 corresponding to the X-axis signals x7, x8 is a negative value. After receiving X-axis differential values from the analogue-to-digital converter 420, the coordinate calculation module 430 will detect that the X-axis differential values Δ x7, Δ x8 are respectively greater than and smaller than the first base value 700. The X-axis differential values Δ x7 and Δ x8 are generated based on the X-axis signals x6, x7, and x8 generated by the corresponding X-axis sensor chains, wherein the X-axis sensor chain X7 is the common in those two sensor pairs and therefore is determined as where the first touch point 600 is located. Based on the relationship stated above, the coordinate calculation module 430 determines that the location of the X-axis sensor chain X7 corresponding to the greater X-axis differential value Δ x7 as the X-coordinate of the first touch point 600. Similarly, the coordinate calculation module 430 will determine that the location of Y-axis sensor chain Y3 corresponding to the greater Y-axis differential value Δ y3 as the Y-coordinate of the first touch point 600. Finally, the coordinate calculation module 430 can achieve touch sensing by identifying the coordinates of first touch point 600 based on the X-axis differential values and the Y-axis differential values. This shows that the X-axis differential values and the Y-axis differential values are used in the present embodiment to determine the X-axis coordinate and the Y-axis coordinate of the first touch point and not only sensing signals. In other words, the touch panel 100 of the present invention can use different algorithm or methods to determine the location of touch point.

Furthermore, in the embodiment illustrated in FIG. 4A, the method of forming the sensor pairs and the calculation of differential values are based on the formula of (Xₙ−Xₙ₋₁). For instance, the X-axis differential value Δ x2 is obtained by subtracting the X-axis signal x1 generated by the X-axis sensor chain X1 from the X-axis signal x2 generated by the X-axis sensor chain X2, but is not limited thereto. In the embodiment illustrated in FIG. 4A, the touch panel 100 has a threshold value 800 for reducing the influence of ambient noise on the touch point detection. In the present embodiment, even if the X-axis differential values x7, Δ x8 are greater than and smaller than the first base value 700 respectively, the difference between the first base value 700 and at least one of the differential values needs to be greater than the threshold value 800. Only if both the criterions are satisfied will the coordinate calculation module 430 determine that the location of X-axis sensor chain X7 as the X-coordinate of first touch point 600. The use of threshold value 800 allows the touch panel 100 to avoid the miscalculation of touch point due to ambient noise or quantization error. In this way, even if the ambient noise is greater in amplitude than the first base value 700, the coordinate calculation module 430 can still reduce the possibility that the touch point is wrongly identified.

FIG. 4B illustrates a variation of the touch panel 100 illustrated in FIG. 4A, wherein embodiments of FIG. 4A and FIG. 4B use different formulae to calculation differential values. In the present embodiment, the calculation of differential values is based on the formula of (Xₙ₋₁−Xₙ). In other words, the differential values in FIG. 4B and those in FIG. 4A are calculated in an opposite manner. In this way, the algorithms of determining touch point in the two embodiments are also performed in an opposite manner. As FIG. 4B shows, the touch panel 100 includes a plurality of X-axis differential values Δ x1, Δ x2, Δ x3, Δ x4, Δ x5, Δ x6, and Δ x7 and a plurality of Y-axis differential values Δ y1, Δ y2, Δ y3, Δ y4, Δ y5, Δ y6, and Δ y7. For instance, after detecting that the X-axis differential values Δ x6 and Δ x7 are respectively smaller than and greater than the first base value 700, the coordinate calculation module 430 will determine that the location of X-axis sensor chain X7 as the X-coordinate of first touch point 600. Other than the calculation of differential values, the touch panel 100 in FIG. 4B is substantially identical to the touch panel 100 illustrated in FIG. 4A and thus is not further elaborated here.

Furthermore, in the embodiments illustrated in FIG. 4A and FIG. 4B, each X-axis differential value is obtained by inputting all the X-axis signals generated by the X-axis sensor chains into the analogue-to-digital converter 420 so that the analogue-to-digital converter 420 can output the X-axis differential values based on the X-axis signals received. For instance, the X-axis signals x1 and x2 are inputted into the analogue-to-digital converter 420 at the same time slot in the first period for the analogue-to-digital converter 420 to generate the X-axis differential value Δ x2. Similarly, the Y-axis signals y4 and y5 are inputted into the analogue-to-digital converter 420 at the same time slot in the first period for the analogue-to-digital converter 420 to generate the Y-axis differential value Δ y5. In the present embodiment, the analogue-to-digital converter 420 can selectively output all the X-axis differential values at the same time slot in the first period or output X-axis differential values separately at different time slots in the first period.

FIG. 4C illustrates another variation of the touch panel 100 illustrated in FIG. 4A, wherein the present embodiment use (Xₙ−Xₙ₋₁) or (Yₙ−Yₙ₋₁) to calculate X-axis differential values and Y-axis differential values. As FIG. 4C shows, the area of first touch point 600 is greater than that in FIG. 4A and FIG. 4B and covers both the X-axis sensor chains X6 and X7; therefore amplitudes of the X-axis differential values Δ x6 and Δ x7 are both greater than the first base value 700. As FIG. 4C shows, the X-axis differential value Δ x7 is greater than the X-axis differential value Δ x6 and therefore the coordinate calculation module 430 initially determines the location of X-axis sensor chain X7 as the X-coordinate of first touch point 600. Afterwards the coordinate calculation module 430 can use interpolation, dispersion or other algorithms to obtain a more precise X-coordinate of the first touch point 600. Similarly, other Y-axis differential values adjacent to the Y-axis differential value Δ y3 can be used to obtain a more precise Y-coordinate of the first touch point 600. This shows that even if the first touch point 600 with different areas are formed on the touch panel 100, the coordinate calculation module 430 can still use a plurality of differential values nearby to obtain a more precise location of the touch point.

FIG. 5 illustrates yet another variation of the touch panel 100 illustrated in FIG. 4A, wherein user touches the touch panel 100 to form a first touch point 600 and a second touch point 610. As FIG. 5 shows, the touch panel 100 includes a first base value 700 and a second base value 710 corresponding to the X-axis differential values Δ x2, Δ x3, Δ x4, Δ x5, Δ x6, Δ x7, Δ x8 and Y-axis differential values Δ y2, Δ y3, Δ y4, Δ y5, Δ y6, Δ y7, Δ y8, respectively. The first touch point 600 and the second touch point 610 are located on the X-axis sensor chain X7 and therefore X-axis differential value Δ x7 corresponding to the X-axis sensor chains X6, X7 is greater than the first base value 700. Furthermore, after detecting that the X-axis differential values Δ x7 and Δ x8 are respectively greater than and smaller than the first base value 700, the coordinate calculation module 430 then determines that the location of X-axis sensor chain X7 as the X-coordinate of at least one touch point. At this moment, the coordinate calculation module 430 has not yet determined all the Y-axis signals and therefore cannot determine how many touch points occur on the touch panel 100.

Furthermore, the first touch point 600 and the second touch point 610 are located on the Y-axis sensors Y3 and Y5, respectively. Thus the Y-axis differential values Δ y3 and Δ y5 are greater than the second base value 710.

The Y-axis sensor chains Y4 and Y6 are not covered by the first touch point 600 and the second touch point 610 and therefore the corresponding Y-axis differential values Δ y4 and Δ y6 are smaller than the second base value 710.

Using the X-axis differential values and Y-axis differential values, the coordinate calculation module 430 will detect that the Y-axis differential values Δ y3 and Δ y4 are respectively greater than and smaller than the second base value 710 and then determine the location of Y-axis sensor Y3 as the Y-coordinate of first touch point 600. Similarly, the location of Y-axis sensor chain Y5 is determined as the Y-coordinate of second touch point 610. After obtaining the Y-coordinates of both touch points 600 and 610, the coordinate calculation module 430 can then achieve multi-touch sensing by determining the location of the first touch point 600 as (X7, Y3) and that of the second touch point 610 as (X7, Y5). Furthermore, the coordinate calculation module 430 can use interpolation, dispersion or other algorithm to process other X-axis differential values and Y-axis differential values to obtain more precise coordinates of the touch points. The touch panel 100 of the present embodiment is used to detect the coordinates of both the first touch point 600 and the second touch point, but is not limited thereto; in different embodiment, the touch panel 100 can be used to detect other number of touch points.

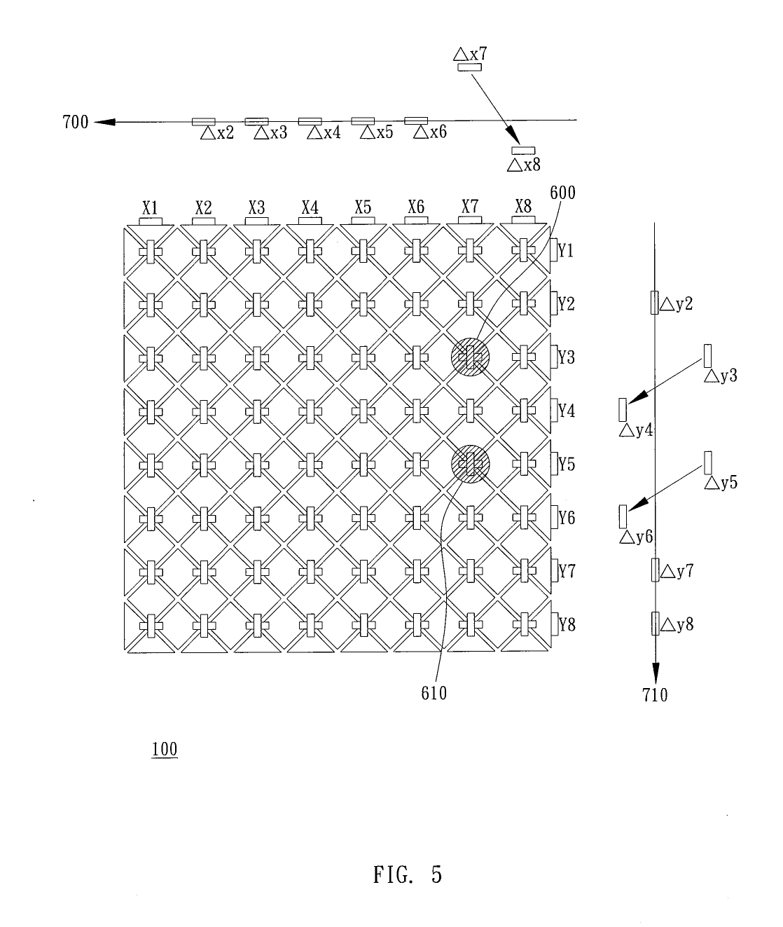

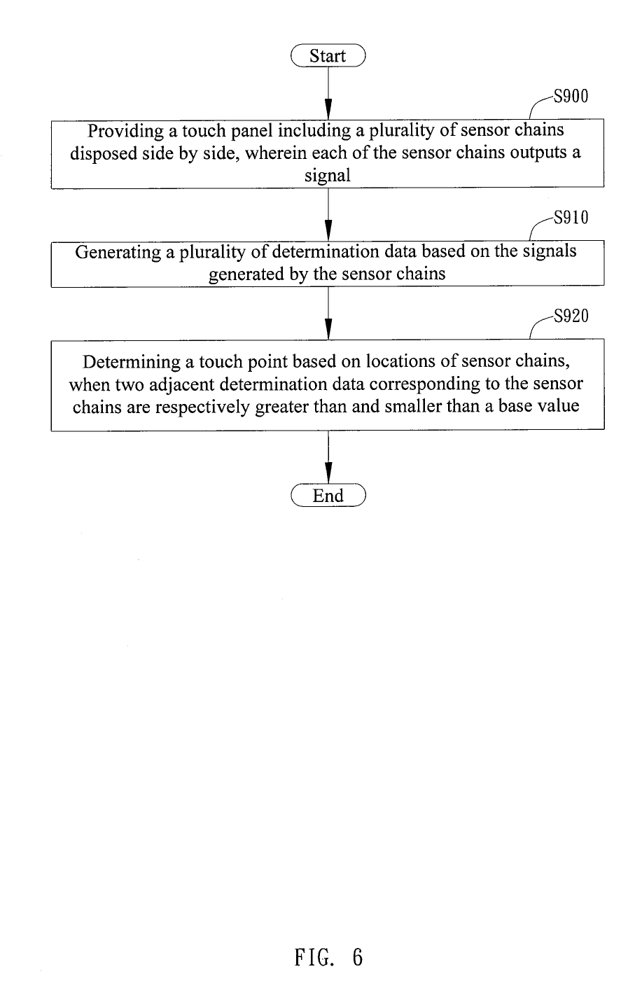

FIG. 6 illustrates a flow chart of the touch sensing method of the present invention. As FIG. 6 shows, the touch sensing method includes step S900 of providing a touch panel including a plurality of sensor chains disposed side by side, wherein each of the sensor chains outputs a signal. In the present embodiment, the touch panel is a capacitive touch panel having a plurality of sensor chains, wherein each of the sensor chains includes a plurality of individual sensors connected to each other. User's touch will change the effective capacitance of the sensors and the corresponding sensor chains which the effect the signals generated by the sensor chains. In different embodiments, the touch panel of the present invention also includes resistive touch panel, surface acoustic wave touch panel, and other different types of touch panels.

The touch sensing method further includes step S910 of generating a plurality of determination data based on the signals generated by the sensor chains. In the present embodiment, signals generated by the sensor chains are transformed from analogue signals into digital signals in order to be processed by a coordinate calculation module, wherein each signal corresponds to one of the sensor chains. As FIG. 6 shows, step S920 includes determining a touch point based on locations of sensor chains, when two adjacent determination data corresponding to the sensor chains are respectively greater than and smaller than a base value. In the present embodiment, when two signals adjacent in sequence are respectively greater than and smaller than a base value, this means that at least one of the sensor chains has sensed user's touch. In the present embodiment, the location of sensor chain corresponding to the signal with higher amplitude is determined as a coordinate of touch point, wherein other signals adjacent in sequence to that signal can also be used together with interpolation, dispersion or other methods to obtain a more precise location of the touch point, but is not limited thereto. In different embodiments, the location of sensor corresponding to the signal with lower amplitude can be used to determine the touch point due to different structure of the touch panel or different components used.

Furthermore, the sensor chains are arranged in an X-axis group and a Y-axis group whereas each group is used to obtain a coordinate for determining a touch point. The sensor chains of the present embodiment are divided into a plurality of X-axis sensor chains generating X-axis signals and a plurality of Y-axis sensor chains generating Y-axis signals. When user touches the sensor chains, the coordinate calculation module will obtain at least one X-coordinate and at least one Y-coordinate based on the X-axis signals and the

Y-axis signals in order to determine the location of touch point. Furthermore, in the present embodiment, the X-axis sensor chains and the Y-axis sensor chains intersect perpendicularly, but are not limited thereto; in different embodiments the X-axis sensor chains and the Y-axis sensor chains can intersect in different angles.

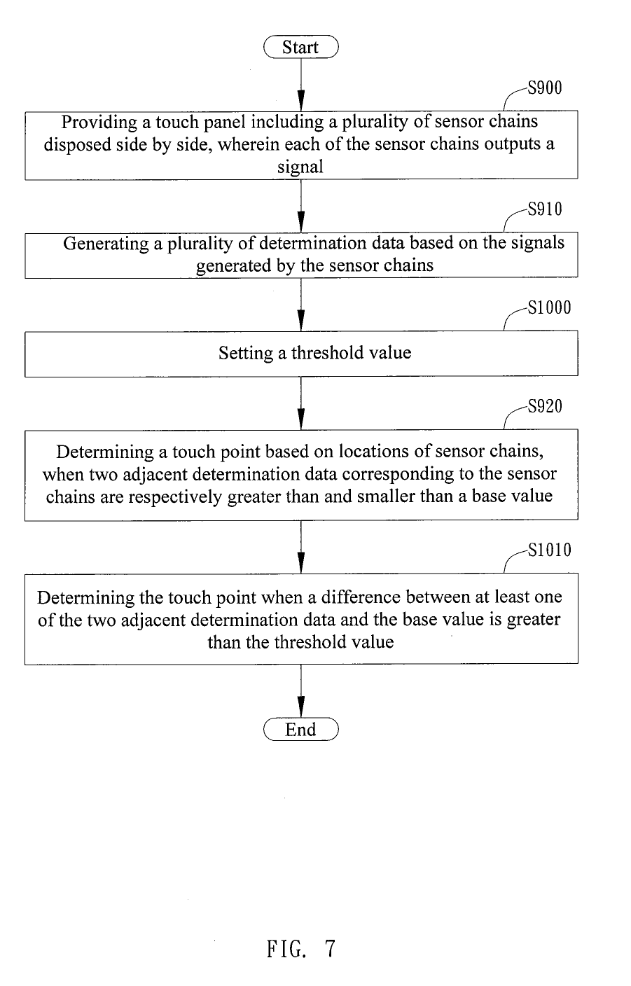

FIG. 7 illustrates a variation of the touch sensing method in FIG. 6. In the present embodiment, the touch sensing method further includes step S1000 of setting a threshold value and step S1010 of determining the touch point when a difference between at least one of the two adjacent determination data and the base value is greater than the threshold value, wherein the location of touch point is based on locations of sensor chains or locations of pairs of sensor chains. The threshold value used in step S1000 is greater than the average amplitude of ambient noise. In the present embodiment, even if the signals adjacent in sequence are respectively greater than and smaller than the base value, the difference between the base value and at least one signal needs to be greater than the threshold value for the touch sensing method to determine the location of touch point. In this way, the touch sensing method of the present invention can use the threshold value to avoid the possibility of determining non-existent touch point due to excessive ambient noise.

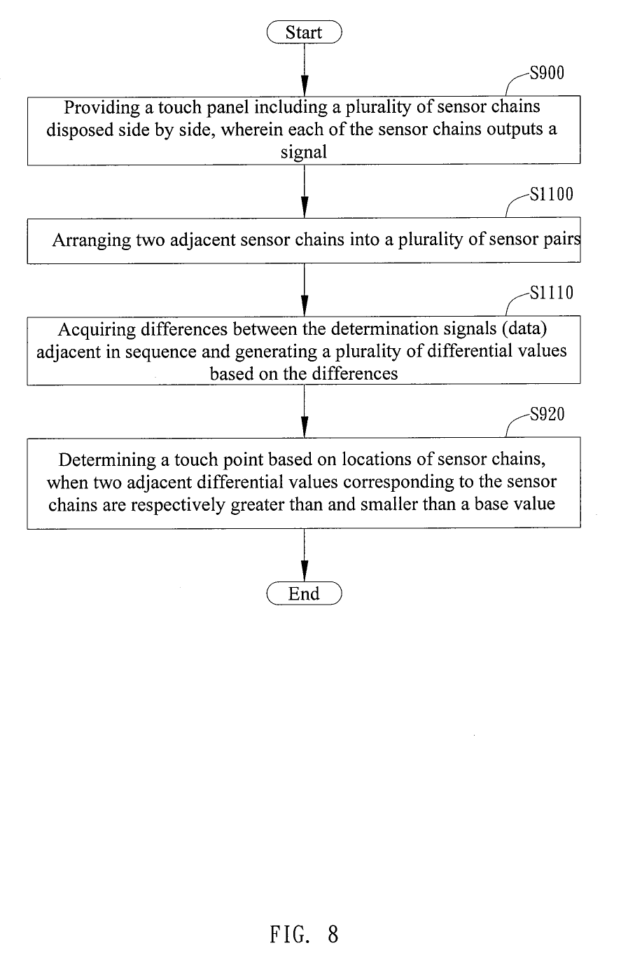

FIG. 8 is a variation of the touch sensing method illustrated in FIG. 6, wherein the touch sensing method of the present embodiment further includes step S1100 of arranging two adjacent sensor chains into a plurality of sensor pairs. In the present embodiment, every two adjacent sensor chains are arranged into a sensor pair. For instance, if the touch panel of the present embodiment has 8 sensor chains arranged side by side and then step S1100 will arrange those sensor chains into 7 sensor pairs. Step S1110 includes acquiring differences between the determination signals (data) adjacent in sequence. In the present embodiment, two signals generated by sensor chains in the sensor pair are inputted into an analogue-to-digital converter, wherein the analogue-to-digital converter will then generate a differential value based on the difference between those two signals. The differential value is the difference in amplitude between signals generated by two adjacent sensor chains. In step S920 of the present embodiment, the differential value is used as a reference to determine the coordinates of touch point, wherein when two differential values adjacent in sequence are respectively greater than and smaller than a base value, step S920 will determine the touch point the location of the sensor chain corresponding to one of the differential values. Furthermore, in the present embodiment, the above-mentioned base value is 0, but is not limited thereto.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A touch sensing method, comprising:
providing a touch panel including a plurality of axial sensors disposed side by side, wherein each of the axial sensors outputs a signal;
generating a plurality of determination data based on the signals generated by the axial sensors in a first period, wherein each of the determination data corresponds to one of the axial sensors or to a plurality of sensor pairs each formed by two adjacent axial sensors;
when two adjacent determination data are respectively greater than and smaller than a base value, determining a touch point based on locations of the sensor pairs or locations of the axial sensors corresponding to the determination data.

2. The touch sensing method of claim 1, wherein the step of determining the touch point includes determining a touch coordinate of the touch point based on two of the determination data respectively greater than and smaller than the base value.

3. The touch sensing method of claim 1, wherein the step of generating the determination data includes acquiring a difference between the determination data of two adjacent axial sensors of the sensor pair at a first time slot of the first period, wherein the difference is used as the determination data corresponding to the sensor pair.

4. The touch sensing method of claim 1, wherein the step of providing the touch panel includes arranging a portion of the axial sensors into a first group according to a first direction and arranging another portion of the axial sensors into a second group according to a second direction, wherein the first direction crosses the second direction, the step of determining the touch point includes acquiring at least one touch coordinate from the first group and at least one touch coordinate from the second group to determine the touch point.

5. The touch sensing method of claim 1, wherein the step of determining the touch point further includes:
setting a threshold value;
when the two adjacent determination data are respectively greater than and smaller than the base value, determining if at least one of the determination data is greater than the threshold value; and
when a difference between at least one of the two adjacent determination data and the base value is greater than the threshold value, determining the touch point based on locations of the axial sensors or locations of the sensor pairs corresponding to the determination data.

6. The touch sensing method of claim 1, wherein the step of determining the touch point further includes:
setting a threshold value;
when the two adjacent determination data are respectively greater than and smaller than the base value, determining if a difference between the determination data and the base value is greater than the threshold value; and
when differences between absolute values of the two adjacent determination data and the base value are both greater than the threshold value, determining the touch point based on locations of the axial sensors or location of the sensor pairs corresponding to the determination data.

7. A touch panel, comprising:
an axial sensing module, comprising a plurality of axial sensors disposed side by side, wherein each of the axial sensors outputs a signal; and
a signal processing module, electrically connected to the axial sensing module to receive the signals from the axial sensors, the signal processing module generating a plurality of determination data based on the signals from the axial sensors generated at a first period, wherein each of the signals corresponds to one of the axial sensors or to one of a plurality of sensor pairs each formed by a pair of adjacent axial sensors;
wherein when two adjacent determination data are respectively greater than and smaller than a base value, the signal processing module determines a touch point based on locations of the axial sensors or the sensor pairs corresponding to the determination data.

8. The touch panel of claim 7, wherein when the two adjacent determination data are respectively greater than and smaller than the base value, the signal processing module determines a touch coordinate based on at least one of the determination data.

9. The touch panel of claim 7, wherein a difference between determination data of two adjacent axial sensors at a first time slot of the first period is used as the determination data corresponding to one of the axial sensors.

10. The touch panel of claim 7, wherein a portion of the axial sensors are arranged into a first group according to a first direction while another portion of the axial sensors are arranged into a second group according to a second direction, wherein the first direction crosses the second direction, the signal processing module requires at least one touch coordinate from the first group and at least one touch coordinate from the second group to determine the touch point.

11. The touch panel of claim 7, wherein the signal processing module includes a threshold value, when the two adjacent determination data are respectively greater than and smaller than the base value while a difference between at least one of the adjacent determination data and the base value is greater than the threshold value, the signal processing module determines the touch point based on locations of the axial sensors corresponding to the determination data.

12. The touch panel of claim 7, wherein the signal processing module includes a threshold value, when the two adjacent determination data are respectively greater than and smaller than the base value while differences between the two adjacent determination data and the base value are both greater than the threshold value, the signal processing module determines the touch point based on locations of the axial sensors corresponding to the determination data.
